(19) United States
(12) Patent Application Publication
(10) Pub. No.: US 2012/0005304 A1
(43) Pub. Date: Jan. 5, 2012

(54) METHOD AND APPARATUS FOR SCALABLE CONTENT MULTICAST OVER A HYBRID NETWORK

(75) Inventors: Yang Guo, Princeton Junction, NJ (US); Sha Hua, Brooklyn, NY (US); Hang Liu, Yardley, PA (US); Yong Liu, Brooklyn, NY (US); Shivendra Panwar, Freehold, NJ (US)

(73) Assignee: THOMSON LICENSING, Princeton, NJ (US)

(21) Appl. No.: 13/138,610

(22) PCT Filed: Mar. 25, 2009
(86) PCT No.: PCT/US2009/001856

§ 371 Date: Sep. 12, 2011

(51) Int. Cl. G06F 15/16

(52) U.S. Cl. 709/217

(57) ABSTRACT

A method and apparatus are described including receiving content from a base station, storing the received content, receiving a second message from a first member of a network, determining a highest expected layer, a lowest layer received by the first member of the network requesting help, a highest layer that needs to be multicast to the first member of the network, and a lowest layer that needs to be multicast to the first member of the network, retrieving the stored content responsive to the message and multicasting the retrieved content to the first member of the network responsive to the determining act.

### FIELD OF THE INVENTION

The present invention relates generally to mobile TV and in particular to multicast/broadcast of mobile TV over cellular networks. The present invention uses advanced video/content coding and dual mobile interfaces to improve quality.

### BACKGROUND OF THE INVENTION

As used herein, “/” denotes alternative names for the same or similar components or structures. That is, a “/” can be taken as meaning “or” as used herein. In multicast/broadcast applications, data are transmitted from a server to multiple receivers over wired and/or wireless networks. A multicast system as used herein is a system in which a server transmits the same data to multiple receivers simultaneously, where the receivers form a subset of all the receivers up to and including all of the receivers. A broadcast system is a system in which a server transmits the same data to all of the receivers simultaneously. That is, a multicast system by definition can include a broadcast system.

In third generation partnership project (3G) cellular networks, the achievable data throughput is inversely proportional to the coverage radius. The existing solutions set the transmission rate at which the entire cell is covered for a given amount of radio resource. Such a design is not optimal since the majority of the viewers inside the cell are “slowed down” by few viewers close to the cell boundary.

Many research groups have already made their contributions in this burgeoning area. Two approaches have been proposed to improve the performance. One approach is to leverage assistance from the base station, and another approach is to leverage the relaying capability of multi-homed hosts. In another project, a unified cellular and ad-hoc network (UCAN) architecture for enhancing cell throughput has been proposed. The 3G base station forwards packets for destination clients with poor channel quality to proxy clients with better channel quality. The proxy clients then use an ad-hoc network including other mobile clients and IEEE 802.11 wireless links to forward the packets to the appropriate destinations. This approach is claimed to improve individual user's throughput by up to 310%.

The above projects were focused on the unicast data transmission in cellular networks. A high speed ad-hoc assisting network constructed by the cell phones themselves can be utilized to improve the overall throughput of the network. And such advantage can be also utilized in the 3G high data rate (HDR) Broadcast/Multicast Services (BCMCS). Based on the UCAN, some researcher developed a new routing algorithm to find efficient ad hoc paths from the proxies to the cellular multicast receivers. The effect of ad hoc path interference is taken into consideration. This approach is claimed to improve the receiver's goodput by up to 280%, where “goodput” is a term used for good output. Yet another project (ICAM) uses a near optimal algorithm for the construction of the multicast forest in the integrated cellular and ad hoc network. It achieves throughput gains up to 840% for 3G downlink multicast. Yet another project proposes a method to provide quality of service (QoS) support by using ad hoc assistant network to recover the loss of multicast data in the cellular network. The conventional literature/projects are all based on the general network infrastructure depicted below as in the FIG. 1, which shows a 3G cellular network with ad-hoc wireless support.

### SUMMARY OF THE INVENTION

As used herein, the term “content” is used interchangeably with the term “video”. “Content” actually includes audio, video, multimedia and any other information or data that can be digitally stored and transmitted. Use of the term “video” interchangeably with the term “content” should not be taken to limit the present invention to video only. A multicast system as used herein is a system in which a server transmits the same data to multiple receivers simultaneously, where the receivers form a subset of all the receivers up to and including all of the receivers. A broadcast system is a system in which a server transmits the same data to all of the receivers simultaneously. That is, a multicast system by definition can include a broadcast system.

As used herein a user/viewer/node is a mobile device and may be a dual mode cell phone, a personal digital assistant (PDA), laptop, client, mobile terminal etc.

Mobile video/content broadcasting/multicasting service, or mobile TV, is expected to become an increasingly popular application for 3G network operators. The service is currently operational, mainly in unicast mode, with individual viewers assigned to dedicated radio channels. However, a unicast based solution is not scalable. Multicast/broadcast service over cellular networks is an attractive solution with the benefits of low infrastructure cost, simplicity in integration with existing voice/data services, and strong interactivity support.

The research leading to the present invention first studied how to improve users' perceived video/content quality utilizing advanced video/content coding and dual mobile interfaces. In 3G cellular networks, the achievable data throughput is inversely proportional to the coverage radius. The existing solutions set the transmission rate at which the entire cellular cell is covered for a given amount of radio resource. Such a design is not optimal since the majority of the viewers inside the cell are “slowed down” by few viewers close to cell boundary.

The present invention uses scalable video coding (SVC) to address the aforementioned issues. In SVC, the video/content is encoded in layers and the video/content quality is proportional to the number of received layers. The base layer is broadcast/multicast to the entire cell to provide basic video/content service. The enhancement layers are broadcast/multicast with decreasing radii to maximize overall viewers' receiving quality. An optimal radio resource allocation strategy is developed. In addition, how to use a mobile device's second interface, such as Wi-Fi interface, to relay enhancement layers (enhancement layer packets) to users/viewers/nodes outside their broadcasting/multicasting ranges was also studied. Optimal strategies with SVC and video/content relaying were developed and various design issues were examined.

A method and apparatus are described including receiving content from a base station, storing the received content, receiving a second message from a first member of a network, determining a highest expected layer, a lowest layer received by the first member of the network requesting help, a highest layer that needs to be multicast to the first member of the network, and a lowest layer that needs to be multicast to the first member of the network, retrieving the stored content responsive to the message and multicasting the retrieved content to the first member of the network responsive to the determining act.

### BRIEF DESCRIPTION OF THE DRAWINGS

The present invention is best understood from the following detailed description when read in conjunction with the accompanying drawings. The drawings include the following figures briefly described below:

FIG. 1 is a schematic diagram of the general topology for a hybrid network.

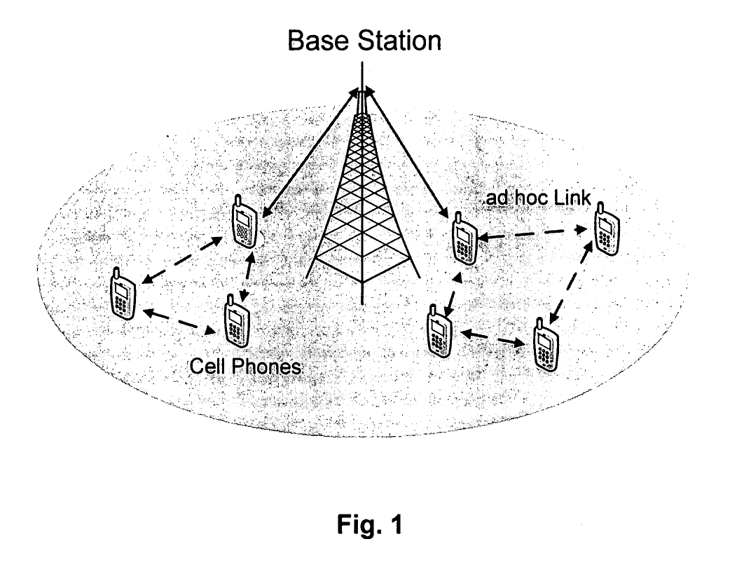

FIG. 2 is a schematic diagram of the use of SVC multicast over a hybrid network assuming three layers of video/content.

FIG. 3 is a schematic diagram of the greedy helper discovery protocol in accordance with the present invention.

FIG. 4 is a schematic diagram of an example of use of the multicast routing protocol in accordance with the principles of the present invention.

FIG. 5 is a schematic diagram of ad-hoc data relay in accordance with the principles of the present invention.

FIG. 6 is a diagram of the ad-hoc relay delay for an arbitrary user/viewer/node with a one hop relay in accordance with the principles of the present invention.

FIG. 7 is a diagram of the ad-hoc relay delay for an arbitrary user/viewer/node with a two hop relay in accordance with the principles of the present invention.

FIG. 8 is a reference diagram to further clarify the positions of the users and helpers for the two hop relay depicted in FIG. 7.

FIG. 9 is a diagram illustrating the increase in the number of users/viewers/nodes that effectively move closer to the base station with the aid of the ad-hoc multicast relay network of the present invention.

FIG. 10 is a block diagram of an exemplary embodiment of a user/helper in accordance with the principles of the present invention.

FIG. 11 is a flowchart of an exemplary embodiment of the message handler portion of a user/helper (mobile device) in accordance with the principles of the present invention.

FIG. 12 is a flowchart of an exemplary embodiment of the data relay portion of a user/helper (mobile device) in accordance with the principles of the present invention.

FIG. 13 is a flowchart of an exemplary embodiment of the operation of a node/mobile device in accordance with the principles of the present invention.

### DETAILED DESCRIPTION OF THE PREFERRED EMBODIMENTS

Nowadays, the demand for content-rich multimedia is rising. Watching a movie or a live TV show on cell phones, at anytime and any place, is attractive to many viewers. Broadcast/Multicast service is, thus, a significant part of 3G cellular services. For instance, Broadcast Multicast Service (BCMCS) is a standard in Third Generation Partnership Project 2 (3GPP2) for providing broadcast/multicast service in the CDMA2000 setting. For such multicast data service, if integrated with Ad-hoc wireless networks, the overall throughput can be greatly improved. However, none of previous studies have considered the specific requirements of content transmission over cellular networks. None of the previous research has taken advantage of the latest advancement in the video/content coding technologies. In the conventional broadcast/multicast service paradigm, the transmission rate is forced to be set at a rate for which the entire cell is covered. The transmission rate is inversely proportional to the coverage size. Hence the users/nodes/viewers closest to the cellular boundary “drag down” the majority of users who are not near the cell boundary and could have enjoyed a higher transmission rate. A higher transmission rate necessarily implies a better overall viewing experience with improved QoS.

In the following, a multicast service method over a 3G cellular network is described that utilizes both Scalable Video Coding (SVC) and an Ad-hoc wireless network. SVC allows the proposed scheme to maximize users' perceived video/content quality by optimally using the radio channel resource. The Ad-hoc wireless network relay further improves the data throughput and thus users' experiences.

### A. Architecture Design

In the scalable video/content broadcast and multicast service (SV-BCMCS) of the present invention, through SVC coding, video/content is encoded into one base layer and multiple enhancement layers. Viewers/users/nodes who/which receive the base layer can view the video/content with minimum quality. Video/content quality improves as the number of received layers increases. An enhancement layer can be decoded if and only if all enhancement layers below it are received. The multicast radio channel of the base station is divided into multiple sub-channels. Different layers of video/content are broadcast/multicast using different sub-channels with different coverage ranges. To maintain the minimum quality for all viewers, the base layer is always broadcast/multicast using a sub-channel that covers the entire cell. To address the decoding dependency of upper/higher layers on lower layers, the broadcast/multicast range of lower layers cannot be less than that of higher/upper layers.

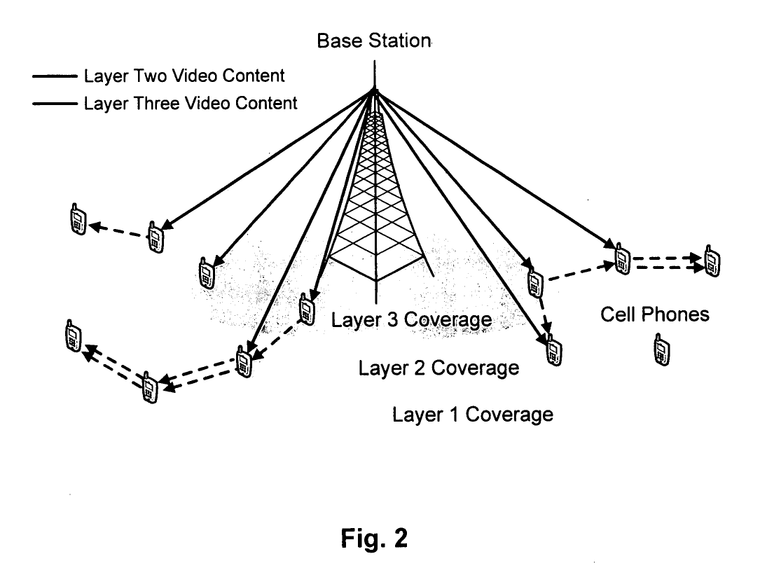

FIG. 2 depicts a simple example of SV-BCMCS scheme with twelve users and three layers of SVC video/content, L1, L2, and L3. The base station multicast three layers in three sub-channels and their coverage is indicated with different shading/fills in the figure. All the users receive L1 from base station directly, while four users receive L2 and three users receive L3. Using an ad-hoc network, the coverage of higher layers is increased further. If user a is in coverage L3 and user b is in coverage L2, for example, then user a relays L3 to user b who then relays L3 to user c and d. Meanwhile, user b relays L2 to user c and d. Effectively, all four users a, b, c, and d receive all three layers through ad hoc network relays.

The key design questions of SV-BCMCS architecture are: (i) how to design an efficient helper discovery and routing protocol; (ii) how to allocate the radio resources among sub-channels such that the users' perceived quality is maximized; and (iii) what kind of impact can ad hoc networks have to improve users' performance. These three questions are studied next.

### B. Optimal Radio Resource Allocation in Layered Video/Content Broadcast/Multicast

An objective of radio resource allocation is to maximize the aggregate user perceived video/content quality while maintaining the minimum quality for all users. In video/content processing, Peak Signal-to-Noise Ratio (PSNR) is widely used as an indicator of video/content quality. From theoretical and empirical studies, normally the higher the received video/content rate, the higher the PSNR. The relationship between video/content quality and PSNR depends on the specific video/content coding schemes. In the following, unless otherwise noted, the receiving data rate is used as the video/content quality metric.

Assume there are L video/content layers, and the transmission rate of each layer is a constant Rᵢ, 1≦i≦L. Let pᵢ denote the fraction of the channel devoted to the transmission of layer i, and rᵢ denotes the actual transmission rate, or PHY mode, selected by sub-channel i. There is a unique sub-channel for each layer. For a mobile system, the total number of PHY modes is fixed. In BCMCS, there are eleven PHY modes according to the 3GPP2 specifications. Individual modes correspond to respective data rates. In order for a sub-channel to transmit a layer of video/content rate Rᵢ, pᵢ=Rᵢ/rᵢ. That is the fraction of the channel devoted to the transmission of layer i is equal to the transmission rate for layer i divided by the actual transmission rate for sub-channel i (assuming a unique sub-channel i for layer i transmissions).

Suppose nᵢ users can correctly receive layer i video/content, i.e., nᵢ users' receiving Bit-Error-Rate (BER) is lower than a specific threshold value for this rate. For simplicity, it can be further assumed that there is no packet error or loss. Therefore nᵢ−nᵢ₋₁ users, 1≦i<L, receive i layers of video/content, and n_{L}, users receive all L layers. The aggregate data rate of all users is:

$$\begin{matrix}U = ( {n}_{1} - {n}_{2} ) \cdot {R}_{1} + ( {n}_{2} - {n}_{3} ) \cdot ( {R}_{1} + {R}_{2} ) + … + ( {n}_{L - 1} - {n}_{L} ) \cdot \\ {\sum }_{i}^{L - 1} {R}_{i} + {n}_{L} \cdot {\sum }_{i}^{L} {R}_{i} \\ = {{\sum }_{i}}^{L} {n}_{i} \cdot {R}_{i}\end{matrix} \qquad ( 1 )$$

For fixed total number of multicast users N in the 3G domain, maximizing the average data rate of multicast users is the same as maximizing the aggregate data rate U in equation (1). Moreover, for a series of given video/content rates Rᵢ, equation (1) indicates that it is only necessary to maximize the summation of nᵢRᵢ, 1≦i≦L.

Next, the computation of nᵢ is discussed. The value of nᵢ is determined by the transmission rate rᵢ for sub-channel i. Due to the path loss, fading, and user mobility, nᵢ varies with rᵢ and generally is a monotonically decreasing function of rᵢ. The higher the transmission rate of the base station, the fewer the users can correctly receive the data. Thus, nᵢ=f(rᵢ). That is, the number of users/nodes that can correctly receive layer i transmissions is a function of the transmission rate for sub-channel i. It can be assumed that the long-term path loss dominates the receiving signal strength, for each transmission rate rᵢ, a corresponding distance dᵢ can be derived based on the BER and signal-to-noise ratio (SNR) requirements for the PHY mode and the total number of users within dᵢ is nᵢ. In a practical implementation, each user can report its average receiving data rate to the base station using the feedback channel. The base station can count nᵢ by comparing these reported rates with the transmission rate rᵢ. The optimal radio resource allocation problem can be formulated as the following utility maximization problem:

### Maximize:

$$U = {\sum }_{i = 1}^{L} f ( {r}_{i} ) {R}_{i} \qquad ( 2 )$$

### Subject to:

$$\begin{matrix}{r}_{i} \leq {r}_{j} i \leq j and i , j = 1 , 2 , … L & ( 3 ) \\ {\sum }_{i = 1}^{L} ( \frac{{R}_{i}}{{r}_{i}} ) \leq 1 & ( 4 ) \\ f ( {r}_{1} ) = N & ( 5 ) \\ {r}_{i} ∈ Φ & ( 6 )\end{matrix}$$

An objective is to find a set of transmission rates rᵢ for each layer, to maximize the average data rate. For the constraint given by equation (6), Φ is the set of all M possible transmission rates (or PHY modes). In BCMCS, M=11. The constraint given by equation (3) ensures that the coverage of lower layers is larger than that of the higher layers. Otherwise, received higher layers cannot be correctly decoded. The constraint given by equation (4) guarantees the sum of sub-channels is no greater than the original channel. The constraint given by equation (5) ensures that the base layer covers the whole cell to provide basic video/content service to all the users. Note that the traditional broadcast/multicast with one single stream becomes a special case of above optimization problem with L=1.

In addition, the impact of ad-hoc wireless relay can be readily included in the optimization model. Ad-hoc relay enlarges the layer coverage. With the same transmission rate rᵢ, the base station can reach a larger number of users f̅(pᵢ)≧f(pᵢ), where f̅(Pi) denotes the number of users that can receive layer i with ad-hoc wireless relay turned on. The analysis of ad-hoc relay is presented below. A dynamic programming method is also developed below to solve the above optimization problem.

### C. Dynamic Programming Method

The optimization problem formulated above can be solved using a dynamic programming method. To facilitate the design of a dynamic programming method, the sub-channel allocation fractions, {pᵢ=Rᵢ/rᵢ}, are rescaled to integers. A large integer, K, is selected such that pᵢK is an integer for all i. K can be 10ⁿ if pᵢ is accurate to n digits.

Define Uᵢ^{k} to be the maximum utility of transmitting layer i with sub-channel fraction less than k/K and define Sᵢ^{k} to be the corresponding transmission rate for layer i. Hence:

$$\begin{matrix}{U}_{i}^{k} = {max}_{{r}_{i} ∈ Φ} f ( {r}_{i} \vert {p}_{i} \leq k \text{/} K ) \cdot {R}_{i} ∀ 1 \leq i \leq L & ( 7 ) \\ {S}_{i}^{k} = arg {max}_{{r}_{i} ∈ Φ} f ( {r}_{i} \vert {p}_{i} \leq k \text{/} K ) \cdot {R}_{i} ∀ 1 \leq i \leq L & ( 8 )\end{matrix}$$

Uᵢ^{k} and Sᵢ^{k} are valued zero if no such pᵢ satisfies the condition. Further define Uᵢ^{k} to be the maximum utility of transmitting first i layers (from layer 1 to layer i) with aggregate sub-channel fraction less than k/K and define S^{k}ⱼ, 1≦j≦i to be the transmission rate for layer j corresponding to Uᵢ^{k}. The dynamic programming method is illustrated in Method 1. Note the method is for a general problem without considering the constraint represented by equation (5). Otherwise the K in line 6 can be replaced with

$${K}^{′} = K ( 1 - \frac{{R}_{1}}{{r}_{1}} ) .$$

The maximum utility is f(r₁)·R₁+U_{L}^{K′}.

Method 1: Dynamic programming method for sub-channel
resource allocation problem

```
  1: for k = 1 to K do
  2:  u₁^{k} = U₁^{k}
  3:  S₁^{k} = S₁^{k}
  4: end for
  5: for i = 2 to L do
  6:  for k = 1 to K do
  7:   m̅ = arg max_{{m∈[l,k] and {s}_{_{i−1}}_{^{m}}_{≦s}_{ᵢ}_{^{k−m}} _{or s}_{ᵢ}_{^{k−m}}_{==0}}}
        {uᵢ₋₁^{m} + Uᵢ^{k-m}}
  8:  uᵢ^{k} = uᵢ₋₁ ^{m̅} + Uᵢ^{k- m̅}
  9:  Sᵢ^{k} = Sᵢ₋₁ ^{m̅} ∪ Sᵢ^{k- m̅}
10:  end for
11:  if Sᵢ^{k-m} == 0 then
12:  return uᵢ^{K}, Sᵢ^{k}
13:  end if
14: end for
15: return u_{L}^{K}, S_{L}^{k}
```

In the above method, lines 5 to 14 update Uᵢ^{k} to include a new layer each time. Lines 7 and 8 solve for the maximum utility. Line 9 expands the S_{L}^{k}, and here it is written as “∪” notationally. The Sᵢ^{k-m}==0 in lines 7 and 11 indicates that no more higher layers can be included into the optimal solution, thus the program ends/returns to the calling program/routine. Otherwise every layer will be allocated and U_{L}^{K} gives the optimal solution. The optimal transmission rate for each layer i is Sᵢ^{K}, 1≦i≦L. The complexity of the algorithm is O(L²K²).

### D. Ad-Hoc Video/Content Relay: Helper Discovery and Relay Routing

In a pure SV-BCMCS solution, users closer to the base station receive more enhancement layers from the base station. These user/viewers/nodes can forward those layers to users farther away from the base station through ad-hoc links. Ad-hoc video/content relays are accomplished in two steps: 1) each user finds a helper in its ad-hoc neighborhood from which to download additional enhancement layers; 2) helpers merge download requests from their clients and forward enhancement layers through local broadcast/multicast.

1) Greedy Helper Discovery Protocol: A greedy helper discovery protocol in the 3G and ad-hoc hybrid network was first presented in Luo (H. Luo, R. Ramjee, P. Sinha, L. E. Li, and S. Lu, “UCAN: A Unified Cellular and Ad-Hoc Network Architecture,” in ACM Mobicom, 2003). In that presentation every node of the multicast group maintained a list of its neighbors, containing their IDs and average 3G downlink data rates within a time window. Users periodically broadcast/multicast their IDs and downlink data rates to their neighbors. Each user greedily selects a neighbor with the highest downlink rate as its helper. Whenever a node wanted to download data from the base station, it initiated helper discovery by unicasting a request message to its helper. Then the helper forwarded this message to its own helper, etc., until the ad-hoc hop limit (time-to-live (TTL)) was reached or a node with local maximum data rate was found. The base station sent the data to the last-hop helper. The helpers forwarded the data in the reverse direction of helper discovery to the requesting node.

In the greedy helper discovery mechanism of the present invention, SV-BCMCS deals with data multicast instead of unicast. The locations of helpers change the resource allocation strategy of the base station. With the same transmission rate rᵢ, the base station can reach a larger number of users f̅(pᵢ)≧f(pᵢ), where f̅(pᵢ) denotes the number of users that can receive layer i with ad-hoc wireless relay turned on. To calculate the optimal resource allocation using ad-hoc forwarding, the base station needs to know exactly which node is getting which layer from which helper. To facilitate efficient relay routing, a node also needs to keep information about the relay requests routed through itself.

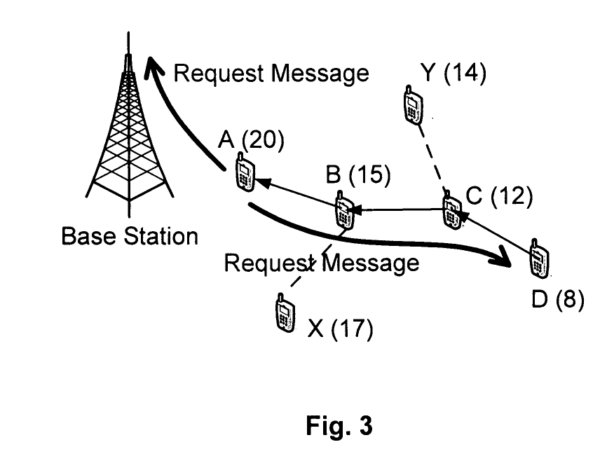

In the helper discovery scheme/method of the present invention, the request message records the IDs of helpers on the path along which the request was forwarded. The last node in the path then sends this final request message both to the base station through the 3G feedback channel, and to the initiating node along the ad-hoc path. This process is shown in FIG. 3. The values in the parentheses are the receiving rates. User D attempts to find a helper within three hops to improve its video/content quality and its request goes through C, B to A. To this end, User A knows where user D is located by the reverse route of the path that user D followed to find user A. User A sends a status message to the base station to indicate that user A will act as user D's helper using the relay path through user B and C. Upon receiving this message, the base station may recalculate its optimal broadcast/multicast strategy by resolving the optimization problem defined in equation (2) with an updated coverage function f̅(pᵢ). Meanwhile, User A also sends a confirmation message back to user D confirming that user A will act as its helper.

The prior art presentation of a greedy helper discovery protocol, also proposed another helper discovery protocol using flooding method. Instead of unicast, each node broadcasts/multicasts the request message hop by hop. This method enabled the node to find the helper with global maximum data rate within ad-hoc hop limit range. However, there is a large overhead when flooding messages in the ad-hoc network. The present invention, thus, only adopts the greedy helper discovery protocol within the SV-BCMCS context.

2) SV-BCMCS Relay Routing Protocol:

The SV-BCMCS routing protocol executes after the optimal radio resource allocation, which is described below. Assuming optimal radio resource allocation has been performed, the base station decides to transmit the L layers with different rates r₁, r₂, . . . , r_{L}. The base station broadcasts/multicasts this information to every node in the cell. Moreover, in the greedy helper discovery phase of the present invention, each node obtained the information for all the paths to which it belongs. The major goal of the relay routing protocol is to maximally exploit the broadcast/multicast nature of ad-hoc transmissions and merge multiple relay requests for the same layer for a common helper. Essentially, each helper needs to determine which received layers will be forwarded to its requesting neighbors. For each node n, its forwarding decision is calculated using method 1.

For the receiving method, each node receives the enhancement layer packets satisfying two conditions: (i) the packets are sent from its direct one-hop helper; (ii) the packets belong to a layer higher than the layer to which the node itself belongs. Otherwise the node will discard the packets. That is, the node has no use for packets that are within the layer to which the node belongs or from a lower layer than the layer to which the node itself belongs. For example, a node that receives L3 packets has no need to receive L2 packets from any other node (helper or otherwise). A node receiving L1 packets would be a grateful recipient of L2 and L3 content packets. The receipt of L2 and L3 content packets would increase the viewing quality for any node receiving only L1 content packets.

Method 2: Forwarding algorithm in SV-BCMCS Routing
protocol for Node n

```
1: N ={ all node k that uses n as one-hop helper }
2: for k ∈ N do
3:  Find the highest layer lₖ that k can directly receive from the base
    station
4:  Find the highest layer Lₖ that k can expect from any potential helper
5: end for
6: lₘᵢₙ = min{lₖ, k ∈ N}
7: Lₘₐₓ = max{Lₖ, k ∈ N}
8: node n Broadcast the packets between layer lₘᵢₙ + 1 to Lₘₐₓ to its
  one-hop neighbors.
```

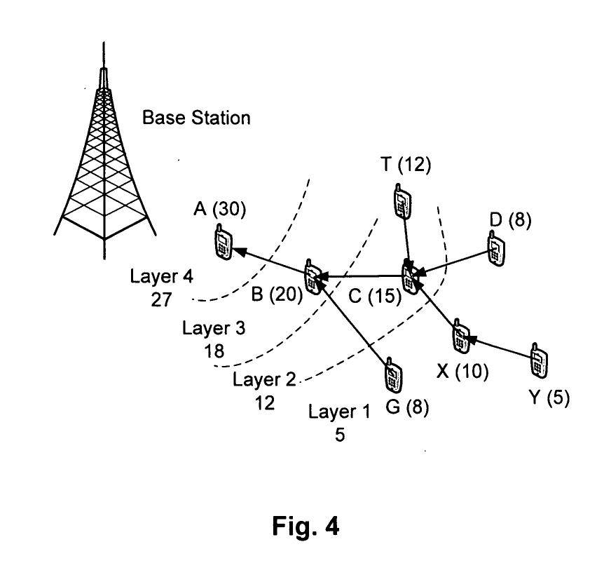

An example shown in FIG. 4 illustrates the above method. The values in parentheses are receiving rates of the various nodes depicted in FIG. 4. Suppose L=4 and maximum number of hops is 2. For node B in FIG. 4, nodes C and G use it as direct one-hop helper. For node C, l_{C}=2 (l_{c} is the layer to which node C belongs) according to FIG. 4, and since node C can reach A within 2 hops, C's highest expected layer is L_{C}=4 (highest expected layer). The highest expected layer is the highest layer which a node can expect to receive through its helpers and constrained by any maximum limit. In the same way, l_{G}=1 and L_{G}=4. That is, node G receives layer 1 and the highest layer node G can expect to receive within two hops is layer 4 via node B and node A. Thus, for node B, lₘᵢₙ=1 and Lₘₐₓ=4. That is, node B receives layer 3 (and can get layer 4 from node A) so l_{b}=3. Since node B can get layer 4 from node A L_{B}=4. Further, since node G receives only layer 1 on its own and node B as node G's helper must send all layers above layer 1 to node G then lₘᵢₙ=1 for node B. Correspondingly, since node G needs layers 2, 3 and 4, for node B, Lₘₐₓ=4, which is the highest layer that node B needs to forward/transmit/multicast/broadcast. Therefore, node B broadcasts/multicasts the enhancement layer packets in layer 2, 3 and 4. Node B's multicast of packets in layers 2, 3 and 4 will be received by both node G and node C. Node B, of course, must receive layer 4 from node A before it can broadcast/multicast layer 4 packets. Since node C already receives layer 2 packets, node C simply discards layer 2 packets that node C has received from node B's multicast. Following the same logic node C multicasts the packets in layer 2 and 3.

Node Y can use node X as a helper. Node C receives layer 2 packets on its own and receives layer 3 and layer 4 packets from node B (which received layer 4 packets from node A). The constraint applied above is that the maximum number of hops is two. That is, that a packet can be relayed at most two hops (twice). That means that node C multicasts layer 2 and 3 packets and does not multicast layer 4 packets since layer 4 packets came from node A which is three hops away/distant. So the best that nodes X and Y can receive is layer 3 packets. Similarly for node D. Node T receives layer 2 packets on its own. When node C multicasts layer 2 and 3 packets, node T will receive layer 2 and 3 packets from node C but will discard layer 2 packets because it already has layer 2 packets. Node C does not make a separate multicast for node T and node G but multicasts packets based on lₘᵢₙ and Lₘₐₓ.

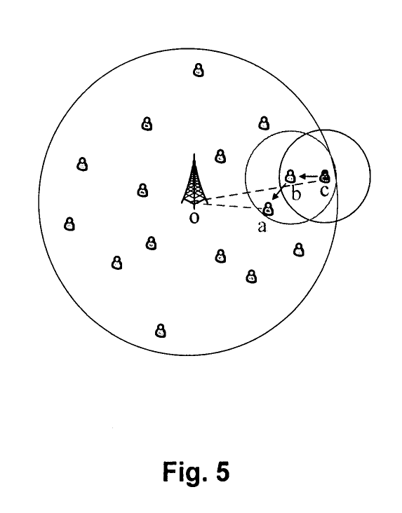

Next the impact of data relay using an ad-hoc network for the user viewing experience is investigated. By relaying the received video/content data to users further away from the base station, the users receiving fewer layers of packets (users/nodes at the coverage edge/boundary) are able to obtain video/content layers they otherwise would not or could not receive. From a system design viewpoint, ad-hoc relay shortens a user's effective distance to the base station. As shown in FIG. 5, user a relays data to user b who then relays the data to user c. Both user b and c have the same effective distance as user a from the base station. The distance gain for user c is the difference of the distance from the base station to user c and distance from the base station to user a. In the following, the distance gain by ad-hoc data relay is probabilistically investigated.

Let G be the distance gain of an arbitrary user with one data relay. Denote by f_{G}(.) as the probability density function (pdf) of G. The probability of distance gain is derived in the following assuming the users are uniformly distributed in the cell. The approach, however, also applies if users obey other distribution functions within the cell.

In some prior art studies, the interference of ad-hoc wireless signals are considered. It is believed that a typical transmission rate of ad-hoc network, such as a network using IEEE 802.11, is much greater than the rate of a cellular network. For instance, IEEE 802.11g supports up to 54 Mbps data rates. Even for IEEE 802.11b, 11 Mbps can be achieved. Hence, wireless interference is not considered in the following study. It is also assumed that the number of data relays, or relay hops, is small. A smaller number of data delays is more robust against user mobility, and reduces the video/content forwarding delay. Furthermore, a smaller number of relays also reduces the impact of wireless interference.

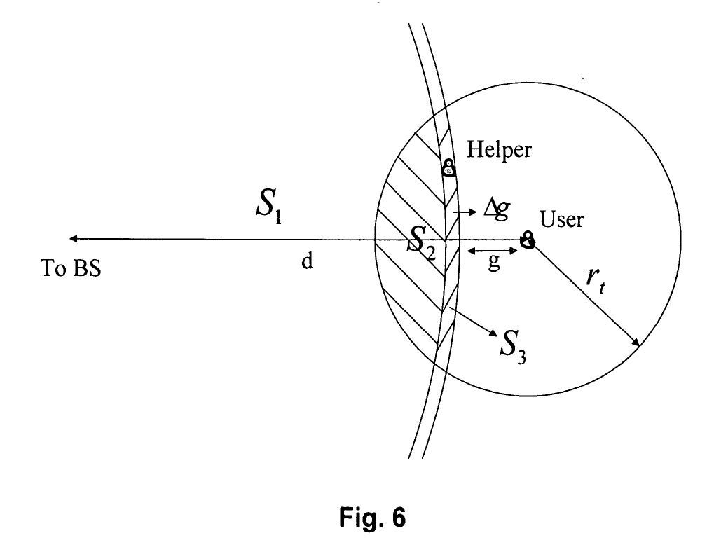

FIG. 6 depicts an arbitrary user and is used to study the user's distance gain in the case of a one hop relay. Assuming that the user is d distance away from the base station, the ad-hoc transmission radius/range is rₜ. All other users falling into the transmission range of the user/viewer/node are potential one-hop helpers. Following the greedy helper discovery protocol, the user/node/viewer closest to the base station is chosen as the relay node. To calculate f_{G}(g), the probability that the distance gain is in a tiny range of [g, g+Δg] is calculated. As illustrated in FIG. 6, the whole cell space is divided into three regions: S₁, S₂ and S₃. Since the relay node is closer to the base station than any other node falling into the transmission range of the user, there should be no node in S₂ in FIG. 6. To achieve a distance gain of [g, g+Δg], there should be at least one node that falls into S₃. Since the area of S₃ is proportional to Δg, the probability that two or more nodes fall in S₃ is a higher order of Δg, thus is ignored. Therefore, the probability of the distance gain in the range of [g, g+Δg] is the probability that when N−1 nodes (excluding the user/viewer/node under study) are dropped in the cell, one node falls into S₃, no node falls into S₂ and N−2 nodes fall into the remaining area S₁. Based on the multinomial distribution:

$$\begin{matrix}{f}_{G} ( g ) = {lim}_{Δ g \to 0} \frac{Pr ( N \text{-} 2 nodes in {S}_{1} , no node in {S}_{2} , one node in {S}_{3} )}{Δ g} \\ = { lim}_{Δ g \to 0} \frac{( N \text{-} 1 ) !}{( N \text{-} 2 ) ! 1 ! 0 !} {( {b}_{1} )}^{N \text{-} 2} {( {b}_{2} )}^{0} \frac{{b}_{3}}{Δ g} \\ = { lim}_{Δ g \to 0} ( N \text{-} 1 ) {p}_{1}^{N \text{-} 2} \frac{{b}_{3}}{Δ g} ,\end{matrix} \qquad ( 9 )$$

where b₁, b₂, b₃ are the probabilities of users located in the area S₁, S2, and S3 respectively. Due to the uniform distribution of the users, bᵢ=Sᵢ/S_{c}, i=1, 2, 3, where S_{c} is the area of entire cell.

Taking a detailed look at how to solve for S₁, S₂, and S₃. S₂ is the overlapping area of two circles. For two circles with known distance d₁₂ between their centers and with known radius of each circle c₁ and c₂ respectively, the overlapping area can be computed. Using S₁₁(d₁₂, c₁, c₂) to represent overlapping area of c₁ and c₂.

For now, S₂=S₁₁(d, rₜ, d−g). For fixed rₜ S₂ is a function of g and d, so using S₂(g; d) below.

$$\begin{matrix}{lim}_{Δ g \to 0} {b}_{1} = 1 - \frac{{S}_{II} ( d , {r}_{t} , d - g )}{{S}_{c}} & ( 10 ) \\ {{lim}_{Δ g \to 0} \frac{{S}_{3}}{Δ g} = - \frac{d {S}_{2} ( g , d )}{d g} = \frac{d {S}_{II} ( d , {r}_{t} , x )}{d x} \vert}_{x = d - g} & ( 11 )\end{matrix}$$

### Consequently,

$${{f}_{G} ( g , d ) = \frac{N \text{-} 1}{{S}_{c}} \cdot {( 1 - \frac{{S}_{II} ( d , {r}_{t} , d - g )}{{S}_{c}} )}^{N \text{-} 2} \cdot \frac{d {S}_{II} ( d , {r}_{t} , x )}{d x} \vert}_{x = d - g} \qquad ( 12 )$$

Therefore the one-hop distance gain can be derived as:

μ_{G}(d)=∫₀^{r}^{ₜ}gf_{G}(g,d)dg

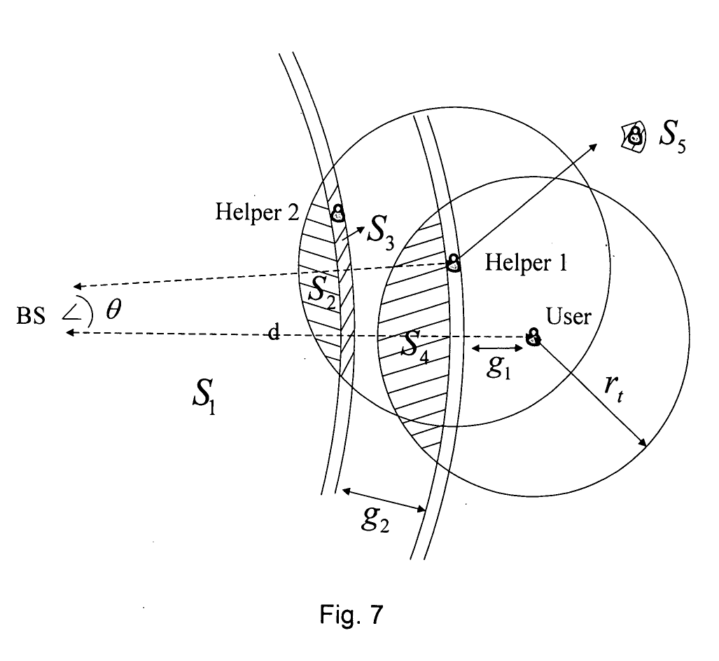

The way to derive the distance gain in the two-hop case is similar to what in the one-hop case. However the two hop case is computationally more complex. Referring to the FIG. 7, using the multinomial distribution, there are five areas S₁, S₂, S₃, S₄, and S₅, to consider with n₁=N−3; n₂=n₄=0, n₃=n₅=1 n₂ and n₄ have to be zero otherwise n₃ and n₅ will not be chosen as helpers. Here nᵢ still represents the number of users in the area Sᵢ. The areas of S_{1˜5} are functions of g₁, g₂, d and θ. It can be determined that S₅=(d−g₁)dθdg₁ and S₁=S_{c}−Σ_{i≦2}⁵S_{i′}. It is fairly difficult to resolve S₂, S₃, and S₄.

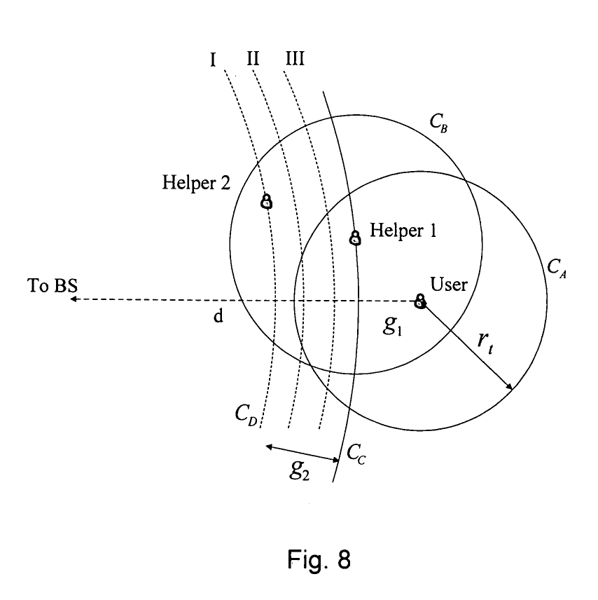

Now taking a closer look at the positions of the user, helper 1 and helper 2 in FIG. 8. Note that the center positions and the radii of the circles C_{A}, C_{B}, C_{C} and C_{D} can be computed based on g₁; g₂; d; rₜ and θ. Going forward S₁(Cᵢ, Cⱼ) is, therefore, defined as the overlapping area of two circles Cᵢ and Cⱼ, and S₁₁₁(Cᵢ, Cⱼ, Cₖ) as the overlapping area of the three circles Cᵢ, Cⱼ, and Cₖ, i, j and k are chosen from A, B, C, D in the example used herein.

With different positions of the helper 2, the C_{D} may intersect with C_{A} and C_{B} in three patterns shown in FIG. 8.

### Case I:

$${S}_{2} = {S}_{II} ( {C}_{B} , {C}_{D} ) , {S}_{3} = - \frac{d {S}_{2}}{d {g}_{2}} , {S}_{4} = {S}_{II} ( {C}_{A} , {C}_{C} ) \qquad ( 13 )$$

In cases II and III, S₂ and S₄ overlap with each other and are combined into one, S₂₄.

Case II:

$${S}_{3} = - \frac{d [ {S}_{II} ( {C}_{B} , {C}_{D} ) - {S}_{II} ( {C}_{A} , {C}_{D} ) ]}{d {g}_{2}} \\ {S}_{24} = {S}_{II} ( {C}_{B} , {C}_{D} ) + {S}_{II} ( {C}_{A} , {C}_{C} ) - {S}_{II} ( {C}_{A} , {C}_{D} ) \qquad ( 14 )$$

Case III:

$${S}_{3} = - \frac{d [ {S}_{II} ( {C}_{B} , {C}_{D} ) - {S}_{III} ( {C}_{A} , {C}_{B} , {C}_{D} ) ]}{d {g}_{2}} \\ {S}_{24} = {S}_{II} ( {C}_{B} , {C}_{D} ) + {S}_{II} ( {C}_{A} , {C}_{C} ) - {S}_{III} ( {C}_{A} , {C}_{B} , {C}_{D} ) \qquad ( 15 )$$

The pdf's in the three cases have the common form as:

$${df}_{{G}_{1} {G}_{2} ( I \cdot II \cdot III )} ( g 1 \cdot g 2 \cdot d , θ ) = \frac{( N - 1 ) ( N - 2 )}{{S}_{c}^{N - 1}} \cdot {S}_{1}^{N - 3} \cdot {S}_{3} \cdot {S}_{5} \qquad ( 16 )$$

with different S₁ and S₃ and S₅ as shown from (13) to (15). In case I, S₁=S_{c}−Σᵢ₋₂⁵Sᵢ. And in case II and III, S₁=S_{c}−S₃−S₂₄−S₅.

### Finally,

$$\begin{matrix}E [ {G}_{1} + {G}_{2} ] = {\int }_{0}^{{g}_{2}^{**}} {Φ}_{( III )} ( g 1 , g 2 , d , θ ) d {g}_{2} + {\int }_{{g}_{2}^{**}}^{{g}_{2}^{*}} {Φ}_{( II )} ( g 1 , g 2 , d , θ ) d {g}_{2} + {\int }_{{g}_{2}^{*}}^{{r}_{t}} {Φ}_{( I )} ( g 1 , g 2 , d , θ ) d {g}_{2} \\ with & ( 17 ) \\ {Φ}_{( i )} ( g 1 , g 2 , d , θ ) = {\int }_{- {θ}^{*}}^{{θ}^{*}} {\int }_{0}^{{r}_{t}} ( {g}_{1} + {g}_{2} ) {f}_{{G}_{1} {G}_{2} ( i )} ( g 1 , g 2 , d , θ ) d {g}_{1} d θ , i = I \cdot II \cdot III & ( 18 )\end{matrix}$$

The critical values of g₂ from case I to II and case II to III are defined as g₂⁺ and g₂⁺⁺, and

$${θ}^{*} = arcsin ( \frac{{r}_{t}}{d} ) .$$

Impact of ad-hoc wireless relay on user performance:

With the aid of ad-hoc wireless relay, the video/content layers can be received by more users. In other words, “more” users appear to exist within certain distance to the base station compared to the scenario with no ad-hoc relay. Next the increase in the number of users with the use of ad-hoc wireless relay can be derived.

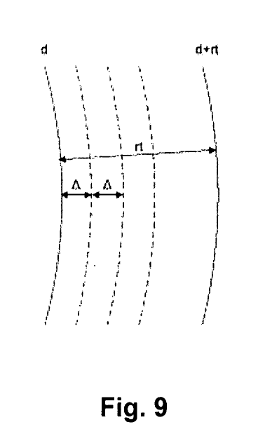

As shown in FIG. 9, an objective is to calculate on average of how many users outside a given distance d can move into the circle, with the aid of ad-hoc relay. The increase represents the number of extra users that can receive a certain video/content layer. The ring is divided between the distance d and d+rₜ into many concentric rings with width of Δ. Note rₜ is the range of ad-hoc transmissions. One-hop ad-hoc relay is considered, however, the approach applies to the multiple hop relay scenario. N is the total number of users in the entire cell, and D is the radius of the cell. The average number of users in the k-th ring is:

$${N}_{k} ( Δ ) = N \cdot \frac{π [ {( d + k Δ )}^{2} - {( d + ( k - 1 ) Δ )}^{2} ]}{π {D}^{2}} = N \frac{Δ [ ( 2 k - 1 ) Δ + 2 d ]}{{D}^{2}} . \qquad ( 19 )$$

Then, the probability that a user in the k-th ring can move into the distance d is

pₖ(Δ)=Σ^{kΔ}^{r}^{ₜ}f_{G}(g,d)dg

The average number of users that move into the circle of radius d is:

$${N}_{ave} = {\sum }_{k = 1}^{[ \frac{{r}_{t}}{Δ} ]} {N}_{k} ( Δ ) \cdot {p}_{k} ( Δ ) . \qquad ( 21 )$$

As Δ→0, equation (17) can be rewritten as:

$${N}_{ave} = {\int }_{0}^{{r}_{t}} \frac{2 N ( d + r )}{{D}^{2}} {\int }_{r}^{{r}_{t}} {f}_{G} ( g , d ) d g d r \qquad ( 22 )$$

Recall in equation (2), with the assistance of ad-hoc network, the base station can reach a larger number of users f′(pᵢ)>f(pᵢ). Now f′(pᵢ) is defined as f′(pᵢ)=f(pᵢ)+Nₐᵥₑ(dᵢ), where dᵢ is the distance for certain transmission rate rᵢ can be derived. That is, f′(pᵢ) is defined as the number of nodes if sub-channel i uses pᵢ fraction of the channel.

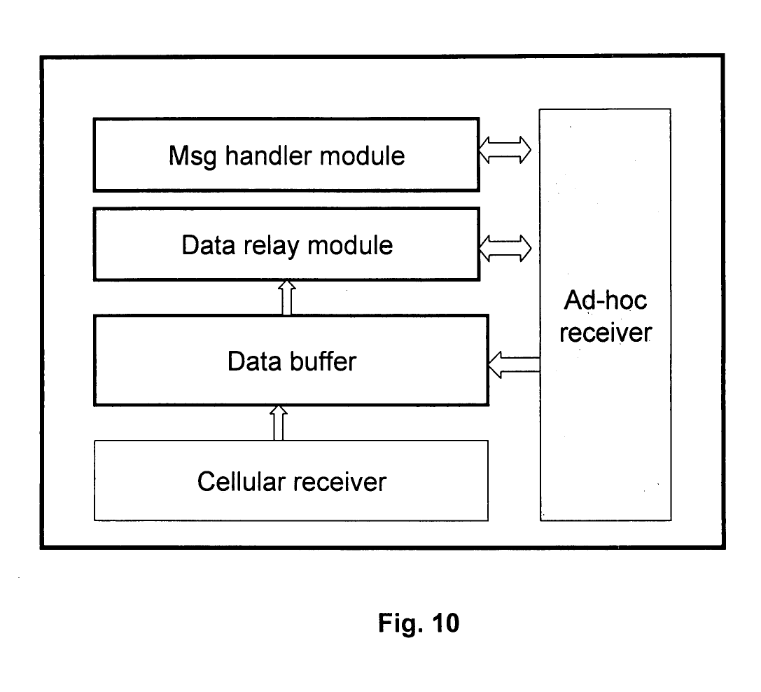

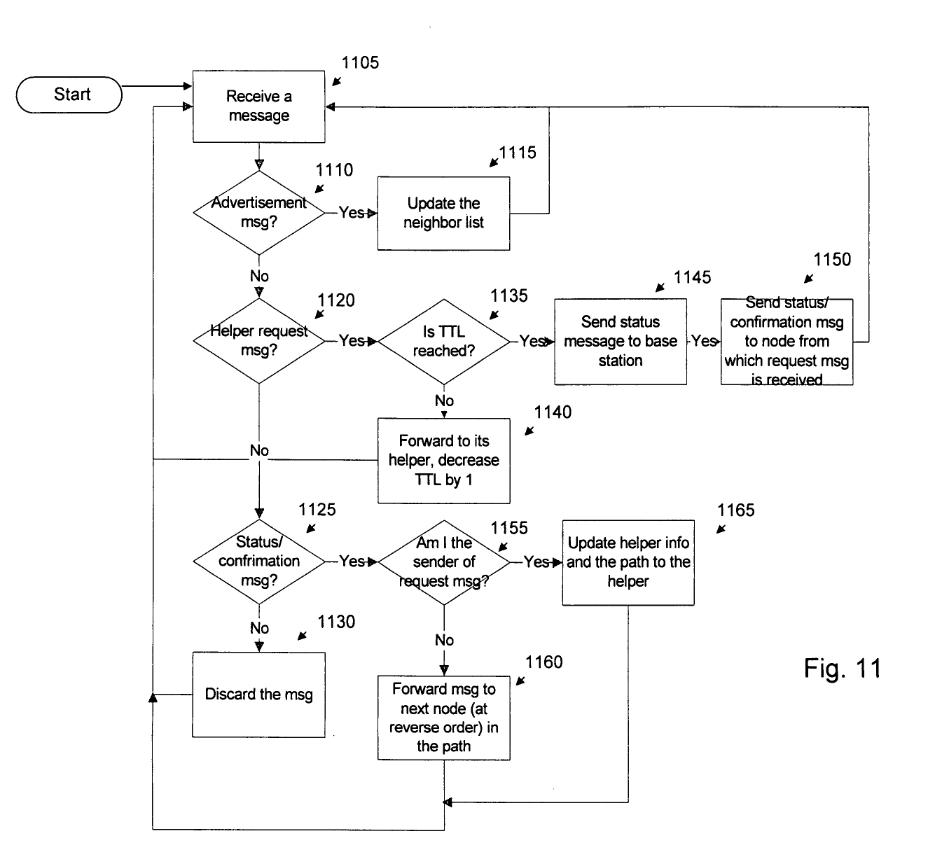

FIG. 10 is a block diagram of an exemplary embodiment of a user/helper in accordance with the principles of the present invention. As used herein a user/viewer/node is a mobile device such as a dual mode smart phone, a PDA, laptop, client, mobile terminal etc. Any user/viewer/node may be a helper to another user/viewer/node depending on where the node is at the time the content packets are received. To that end, each mobile device is equipped and configured to function as both a user and a helper. The cellular receiver function receives content packets via this interface to the cellular communication system. Content/video/data packets that are received are stored in the data buffer for rendering. The ad-hoc receiver portion of the mobile device interfaces to the ad hoc data relay network. It is through the ad hoc receiver portion that the mobile device is able to send/receive messages and data (video/content) packets with other members of the ad hoc hybrid network. Messages such as status, confirmation messages etc are both transmitted and received from the ad hoc hybrid network (via the ad hoc receiver portion). Messages are processed by the message handler module in accordance with the flowchart depicted in FIG. 11. The data relay module also interfaces with the ad hoc network via the ad hoc receiver portion of the mobile device. The data relay module processes data (video/content) packets received from the ad hoc network (via the ad hoc receiver portion) of the mobile device. The data relay module also transmits any data (video/content) packets to other mobile devices when this mobile device acts as a helper to another node.

FIG. 11 is a flowchart of an exemplary embodiment of the message handler portion of a user/helper (mobile device) in accordance with the principles of the present invention. At 1105 the mobile device receives a message. The mobile device performs a test at 1110 to determine if the received message is an advertisement message. An advertisement message is a message containing information from the neighbor nodes of the current node/user/viewer regarding the status of the neighbor node such as for example, the quality of the link between the neighbor node and the current node/user/viewer. At 1115, if the message was an advertisement message, then the current node updates its neighbor list with any information in the advertisement message. A neighbor list is just one form of data base structure for storing neighbor information. Other forms include queues and dequeues. All of the above structures (and many others) are forms of data base structures. If the received message is not an advertisement message then at 1120 the mobile device performs a test to determine if the received message is a helper request message from a neighbor node. If the received message was not a helper request message then the current mobile device performs a test at 1125 to determine if the received message is a status confirmation message. A status/confirmation message is received from another node/mobile device and if it is received from another node/mobile device the status/confirmation message indicates that another node has agreed to be the helper of this node or that another node has agreed to be a helper to another node and the current node is in the helping path. If the received message is not a status/confirmation message then at 1130 the current node/mobile device discards the received message because it is not a recognized message. If the received message is a status/confirmation message then at 1155 the current node/mobile device performs a test to determine if the current node/mobile terminal requested help form another node and the status/confirmation is in response to that request. If the current node/mobile device determines that it sent a helper request message and the received message is a status/confirmation in response to its helper request message then the current node/mobile device updates its helper information and the path to the helper at 1165. Processing then proceeds to 1105. If the current node/mobile device determines that it did not send a helper request message and the received message is not a status/confirmation in response to its helper request message then the current node/mobile device forwards the received message to the next node/mobile device in the path (reverse order) at 1160. Processing then proceeds to 1105. If the received message is a helper request message then the current node/mobile device performs a test at 1135 to determine if the time to live has expired. If the time to live has expired then at 1145 the current node/mobile device sends a status message to the base station. The current node/mobile device then also sends a status/confirmation message to the node from which the current node/mobile device received this helper request message. Processing then proceeds to 1105. If the time to live has not expired for the received message (helper request) then at 1140 the current node/mobile device forwards the received helper request message to its helper decreased by 1.

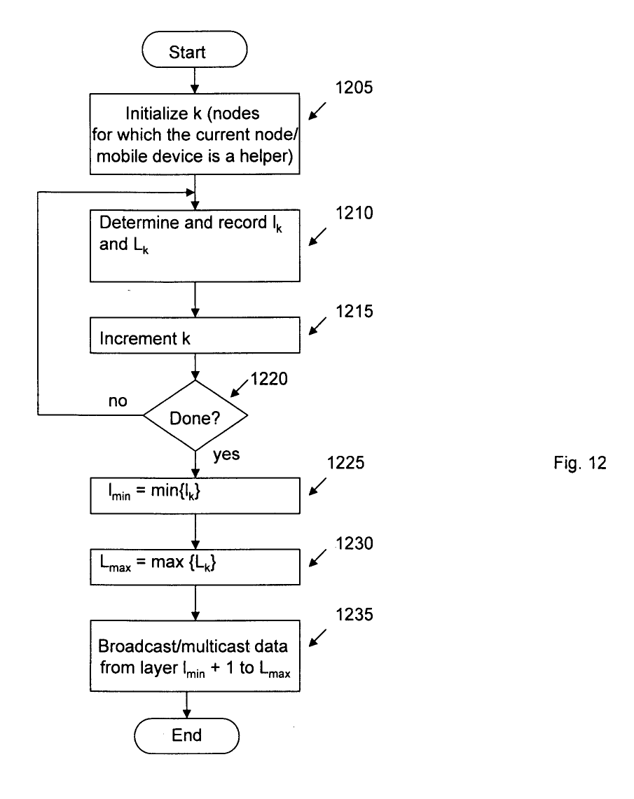

FIG. 12 is a flowchart of an exemplary embodiment of the data relay portion of a user/helper (mobile device) in accordance with the principles of the present invention. It is assumed for the purposes of this flowchart that the current node/bile device is a helper for another node/mobile device. The processing described is for the data relay module. At 1205 k is initialized. For each node/mobile device for which the current node/mobile device is a helper the current node/mobile device determines and records lₖ and Lₖ at 1210. At 1215 k is incremented and then at 1220 a test is performed to determine if the determinations of 1210 are done. That is, k is tested against the maximum number of nodes for which the current node/mobile device is a helper. If the determination and recordation process is not done, then processing proceeds to 1210. If the determination and recordation process is done then at 1225 lₘᵢₙ is determined to be the minimum of the lₖ's determined at 1210. At 1230 Lₘₐₓ is determined to be the maximum of the Lₖ's determined at 1210. At 1235 the data (video/content) in layers lₘᵢₙ+1 to Lₘₐₓ are multicast to the nodes/mobile devices requiring help and for which the current node/mobile device is a helper.

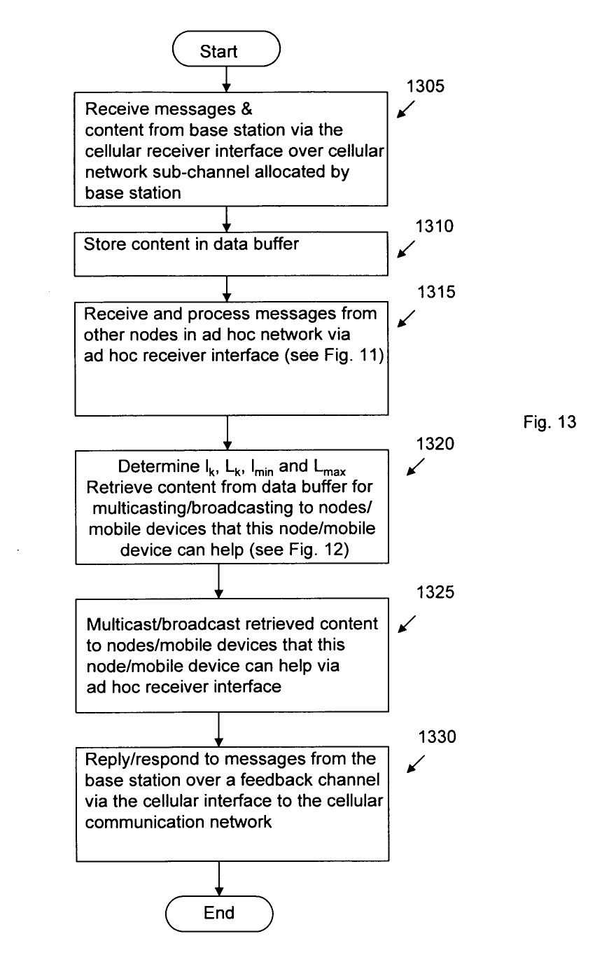

FIG. 13 is a flowchart of an exemplary embodiment of the operation of a node/mobile device in accordance with the principles of the present invention. At 1305 the node/mobile device receives messages and content from the base station via the cellular receiver interface over the cellular network on the sub-channel allocated to the node/mobile device by the base station. That is, the node/mobile device receives at least one message from the base station informing the node/mobile device which sub-channel is allocated to the node/mobile device by the base station and the transmission rate. The node/mobile device also receives content from the base station. The content received by the node/mobile device includes at the least layer 1, which is multicast/broadcast to all nodes/mobile devices in the cell. Depending on where the node/mobile device is at any given time, the node/mobile device may also receive one or more enhancement layers that were coded by the base station or content provider using SVC. At 1310 the node/mobile device stores the received content in a data buffer. The data buffer can be any form of memory/storage. At 1315 the node/mobile device receives and processes messages from other nodes/mobile devices in an ad hoc wireless network to which the node/mobile device belongs. The messages received are received via the ad hoc receiver interface of the node/mobile device which is in communication with the ad hoc wireless network. Details of the message processing are in FIG. 11. At 1320 the node/mobile device determines lₖ, Lₖ, lₘᵢₙ, Lₘₐₓ (all defined and described above). The data relay portion of the node/mobile device also retrieves any stored content from the data buffer so that the node/mobile device can relay the content to other nodes/mobile devices in the ad hoc wireless network that need help in improving their viewing quality. This help comes in the form of the node/mobile device multicasting/broadcasting any content that it has. The node/mobile device may also be a receiver of help and may, in fact, receive content form another (helper) node. The receipt of content is also via the ad hoc receiver interface and is stored in the data buffer. At 1325 the node/mobile device multicast/broadcasts retrieved content to node/mobile devices in the ad hoc wireless network that this node/mobile device can help. The multicasting/broadcasting is accomplished via the ad hoc receiver interface over the ad hoc wireless network. The node/mobile device can multicast/broadcast any data stored in its data buffer subject to any hop constraints as described above. At 1330 the node/mobile device may also respond/reply to any messages it received from the base station or transmit/send/unicast status messages to the base station via the cellular receiver interface over the cellular communication network.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for maximizing an average received content quality at a user device, said method comprising:
receiving, at said user device, content from a base station via a first network;
storing said received content in said user device;
receiving a message from a first member of a second network;
first determining a highest expected layer, a lowest layer received by said first member of said second network requesting help, a highest layer that needs to be multicast to said first member of said second network, and a lowest layer that needs to be multicast to said first member of said second network, wherein said highest expected layer is a highest layer that said user device can expect to receive through members of said second network;
retrieving said stored content responsive to said message; and
multicasting said retrieved content to said first member of said second network responsive to said first determining act.

2. The method according to claim 1, further comprising receiving content from a second member of said second network.

3. The method according to claim 1, further comprising:
second determining if said message is an advertising message;
updating a neighbor data base responsive to said determination;
third determining if said message is a help request message;
fourth determining if said message has expired responsive to said second determination;
transmitting, over said first network, a first status message to said base station responsive to said third determination;
transmitting, over said second network, a response to said first member of said network to said message responsive to said third determination;
fifth determining if said message is a second status message;
sixth determining if said message is a response to said help request message responsive to said fifth determination;
updating information for a helper and path information for said helper responsive to said sixth determination; and
forwarding, over said second network, said message along a reverse path responsive to said sixth determination.

4. The method according to claim 3, further comprising discarding said message responsive to said fifth determination.

5. An apparatus for maximizing an average received content quality at a user device, comprising:
means for receiving, at said user device, content from a base station via a first network;
means for storing said received content in said user device;
means for receiving a message from a first member of a second network;
first means for determining a highest expected layer, a lowest layer received by said first member of said second network requesting help, a highest layer that needs to be multicast to said first member of said second network, and a lowest layer that needs to be multicast to said first member of said second network, wherein said highest expected layer is a highest layer that said user device can expect to receive through members of said second network;
means for retrieving said stored content responsive to said message; and
means for multicasting said retrieved content to said first member of said network responsive to said first means for determining.

6. The apparatus according to claim 5, further comprising means for receiving content from a second member of said network.

7. The apparatus according to claim 5, further comprising:
second means for determining if said message is an advertising message;
means for updating a neighbor data base responsive to said means for determining;
third means for determining if said message is a help request message;
fourth means for determining if said message has expired responsive to said second means for determining;
means for transmitting, over said first network a first status message to said base station responsive to said third means for determining;
means for transmitting, over said second network, a response to said first member of said network to said message responsive to said third means for determining;
fifth means for determining if said message is a second status message;
sixth means for determining if said message is a response to said help request message responsive to said fifth means for determining;
means for updating information for a helper and path information for said helper responsive to said sixth means for determining; and
means for forwarding, over said second network, said message along a reverse path responsive to said sixth means for determining.

8. The apparatus according to claim 7, further comprising means for discarding said message responsive to said fifth means for determining.
